(19) United States
(12) Patent Application Publication
(10) Pub. No.: US 2007/0171056 A1
(43) Pub. Date: Jul. 26, 2007

(54) Position switch for non-contacting state identification

(76) Inventor: Ralf Beyer, Erlangen (DE)

Correspondence Address: HARNESS, DICKEY & PIERCE, P.L.C., P.O.BOX 8910, RESTON, VA, 20195, US

(21) Appl. No.: 11/642,839

(22) Filed: Dec. 21, 2006

(30) Foreign Application Priority Data
Dec. 22, 2005 (EP) EP05028137

(51) Int. Cl. G08B 13/08; G08B 13/14

(52) U.S. Cl. 340/545.2; 340/572.7

(57) ABSTRACT

A position switch is disclosed for non-contacting state identification with at least two switching states, at least one identification device and at least one device for shielding. The at least one device for shielding is provided in order to interrupt and reproduce a data transmission from a coupling element to a reader. The aim of this is to ensure that the state of the position switch can be identified safely, reliably and securely, and in a cost-efficient manner. The position switch may at least partially be in the form of a circuit arrangement, safety or security system, hinge switch or an alarm installation.

### PROIRITY STATEMENT

The present application hereby claims priority under 35 U.S.C. §119 on European patent application number EP 05028137 filed Dec. 22, 2005, the entire contents of which is hereby incorporated herein by reference.

### FIELD

Embodiments of the invention generally relate to a position switch. For example, it may relate to one for non-contacting state identification with at least two states and an identification device. Further, the identification device may include at least one reader and at least one coupling element, which are provided for non-contacting data transmission using one transmission frequency. The embodiments of the invention also generally relate to a safety or security system and to a corresponding method.

### BACKGROUND

A position switch or method is used both in private fields and industrial fields. The position switch is of relevance wherever there is a need to detect state of, for example appliances, switches, elements to be operated, in particular doors, shutters or any other element which has at least two different states.

In the private field, applications occur, for example, in the domestic field in alarm installations, safety, security or switching boxes, monitoring systems or systems for presence monitoring.

In the industrial field, applications occur in the fields of switching, automation, monitoring and in the field of tracking systems.

One major advantage of non-contacting detection is its flexibility in use. In general, there is no need for complicated wiring or mechanical contacts, or contact surfaces that are susceptible to defects. This reduces the material required and simplifies use in particular in areas in which the use of cables would result in specific hazard potentials, unnecessary complexity, or impediments. Furthermore, the mobility that this results in, since there is no need to provide any additional cable links, allows the system to be used broadly. The location of use of the appliances or elements whose state is intended to be monitored or recorded is thus not fixed, and can be changed in a very short time.

Furthermore, non-contacting state identification systems allow retrospective upgrading of existing appliances and elements, without major effort. In this case, the recording can be carried out by means of a reader which is fitted centrally, in order to monitor a plurality of units.

By way of example, in automation installations, switching states of switches, such as circuit breakers (power circuit breakers, motor circuit breakers, etc) must be recorded electronically. In general, wiring for these circuit breakers is highly complex. The wiring problem becomes worse with the complexity of the automation installation, and of its components. Non-contacting state identification in the case of automation installations is clearly advantageous. Furthermore, it has become normal practice to connect a circuit breaker mechanically to an auxiliary switch in order to ensure that the switching state can be detected indirectly via the auxiliary switch. The auxiliary switch is therefore used only to detect the switching state.

The auxiliary switch is generally connected by wires via an input/output station. The switching state is generally transmitted by way of a fieldbus to a controller, where it is processed further. In consequence, auxiliary switches are used wherever the actual circuit breaker cannot be connected to the controller/monitoring, and cannot be retrofitted to do so. The function of the auxiliary switch is therefore to compensate for the incompatibility of the circuit breaker for connection to the fieldbus.

The auxiliary switch solution at the moment has various disadvantages:

Every auxiliary switch must be connected to an input/output station and to a power supply. In addition, inputs to the input/output stations are in fact now required. The wiring and the use of input/output stations results in large-volume switching cabinets. The cumbersome hardware and wiring complexity is thus high, and costly.

In addition, the identification of the switching states is dependent on the reliability of the mechanical and electrical arrangement. First of all, the mechanical fitting of an auxiliary switch to a circuit breaker is relevant for identification. However, the mechanical connection conceals potential risks of non-identification. The additional wiring complexity likewise results in a certain hazard potential in terms of non-identification if, for example, contacts are not correctly set up or one of the appliances that are provided for identification purposes is faulty. Particularly in the case of automation installations, the reliability of the state detection is substantially important. Non-identification can lead to a hazard to personnel, or to a production failure.

A further solution approach for state identification is to use cameras, although the complexity with this solution is likewise high since, in this case, potentially faulty identification devices, in particular electronic identification means, are used. Furthermore, an image identification method must be used, and this additionally results in the complexity becoming unreasonably high.

DE 199 33 686 A1 discloses a switch with wire-free remote reading. A central unit transmits checking signals which are reflected in a differently coded form, or are even not reflected, by one or more switches. The central unit uses these reflected signals to determine the switching states of the switches.

US 2003/0016136 A1 discloses an RFID-integrated circuit, which teaches a circuit with shielding of an antenna.

Furthermore, U.S. Pat. No. 6,412,813 B1 discloses a system which transmits waves for non-contacting detection of a child's seat in a vehicle, and subsequently analyses these waves.

### SUMMARY

In at least one embodiment a cost-saving position switch is specified, which can be used widely, and a safety or security system for no-contacting state identification.

In at least one embodiment, a position switch includes a device for shielding, with the device for shielding being provided in order to interrupt and reproduce data transmission from the coupling element to the reader, in which case at least one device for shielding can be activated when a state change occurs. A safety or security system and a corresponding method are also disclosed.

According to at least one embodiment of the invention, the position switch for non-contacting state identification has at least two switching states. In addition, it has at least one identification device, with the identification device being provided for identification by way of non-contacting data transmission using one transmission frequency. The non-contacting data transmission takes place between at least one reader and at least one coupling element. For example, the coupling element and a data store represent components of a radio-frequency identifier (RFID).

Furthermore, in addition to the coupling element, the reader represents at least one identification device in the safety or security system for non-contacting state identification. In this case, the reader acts as a receiver, and the coupling element as the element which transmits the data. According to at least one embodiment of the invention, the position switch or the safety or security system has at least one device for shielding. The device of shielding are provided in order to interrupt and reproduce the data transmission from the coupling element to the reader. The shielding in this case relates to the shielding of the radio waves which are required for non-contacting data transmission.

The lack of mechanical parts and electronic appliances for state detection results in the position switch having high detection reliability. Furthermore, the complexity for production of a system according to the invention is reduced.

The position switch can advantageously be designed in such a manner that the reader and/or the coupling element are provided for shielding. The shielding of the reader prevents the transmission of a checking signal. Shielding of the coupling element, which is likewise possible, is intended to prevent reception of a checking signal such as this. The use of one or the other type of shielding is advantageous with respect to the respective application.

For example, if the aim is to monitor a plurality of switches with coupling elements, it is worthwhile providing shielding on the coupling element. It is thus possible to distinguish between a plurality of switching states. Conversely, it is worthwhile shielding the reader if, for example, the coupling elements only temporarily enter the reading area of the reader, and the reader is not intended to read the coupling elements which may be accessible.

In one advantageous embodiment, a switching state of the position switch can be indicated by the use of at least one device for shielding. The use of at least one device for shielding allows effective consideration of the respective appliance or element. It is also possible to determine as a function of this whether a device for shielding or a plurality of devices for shielding is or are required for effective shielding. For example, it is worthwhile to combine the device that is used for shielding with the operator in an interlocking or integral manner.

One advantageous embodiment couples the device for shielding at least partially mechanically, and/or to a switching mechanism. The use of a locally provided switching mechanism for integration of at least one device for shielding has a space-saving and positive effect on the detection reliability.

One advantageous embodiment provides at least one device for shielding in order to interrupt and reproduce a non-contacting power supply via the coupling element. Non-contacting data transmission is avoided by the capability to decouple the coupling element from the power supply. This results in a non-contacting power supply which can be used or interrupted as required. In consequence, it is also possible to operate the coupling element exclusively in a non-contacting manner, that is to say without any local power supply, in order in this way further to reduce the wiring complexity and design effect. At the same time, the non-contacting power supply allows checking thereof by the device for shielding.

The device for shielding advantageously includes at least one metallic and/or metallized component. The use of metals in this context is seen in the capability to shield radio waves. At the same time, a metallic or metallized component such as this can be used in a switching mechanism or within the appliance or element. The purpose of the component is in consequence to allow at least two functions to be carried out. One advantageous embodiment activates at least one device for shielding by a change in the state. A state change automatically implies operation of at least one device for shielding, so that the state of the system can be indicated.

In a further advantageous embodiment, the data in a data store can be read in a non-contacting manner in a first state, and cannot be read in a non-contacting manner in a second state. The data is taken from the data store and can be read or not in a non-contacting manner by the reader via the coupling element, as a function of the state. If two states exist, the transmission of the data is the verification of a first state, and the non-transmission of the data is the verification of the second state. Furthermore, it is worthwhile providing the data for identification of a unit. The unit and its state are thus clearly known on reception of data which is intended for identification.

The reader is advantageously provided as an integrated or mobile reader. An integrated reader in consequence has a monitoring task, with a mobile reader having a task which is similar to reading or checking.

### BRIEF DESCRIPTION OF THE DRAWINGS

Further advantageous embodiments and preferred developments of the invention can be found in the description of the figures and/or in the disclosure.

The invention will be described and explained in more detail in the following text, with reference to the disclosed example embodiments which are illustrated in the figures, in which:

FIG. 1 shows an illustration of a potentially hazardous machine with a closed cover, according to a first example embodiment,

FIG. 2 shows an illustration of the potentially hazardous machine with an open cover, according to the first example embodiment,

FIG. 3 shows a view of a hinge switch according to the second example embodiment,

FIG. 4 shows a view of a position switch according to a third example embodiment, and

FIG. 5 shows an illustration of an alarm installation according to a fourth example embodiment.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described.

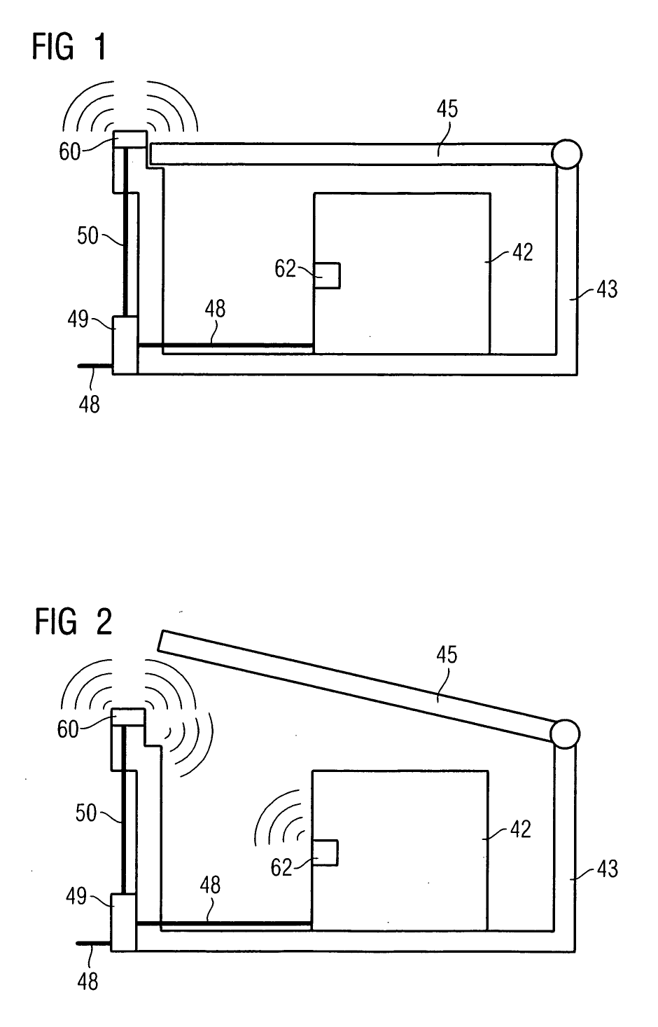

FIG. 1 shows an illustration of a potentially hazardous machine 42, with a closed cover, according to a first example embodiment. The potentially hazardous machine 42 is located in a safety or security container 43, which can be closed by a moveable cover 45. The safety or security container 43 furthermore has a reader 44 in the vicinity of the cover opening and this reader 44 is connected to a circuit breaker 49 via a control line 50. The circuit breaker 49 has device for monitoring the power supply to the potentially hazardous machine 42.

In this example embodiment, the safety or security container 43 and its cover 45 represent means for shielding of the RFID 62 of the potentially hazardous machine 42. In the closed state, the reader 44 is not able to produce a non-contacting data transmission to the RFID 62. If the cover 45 is closed, the state of the entire arrangement corresponds to the first state of the safety or security system.

A wide range of machines, such as a circular saw, a laser inscription installation or an X-ray appliance may be regarded as potentially hazardous machines 42.

The RFID 62 can advantageously always be used in conjunction with the potentially hazardous machine 42, even when, for example, it is used in a different safety or security container. It can thus be used at a different location just by removing it and reinserting it again without any further wiring effort. The same RFID 62 can therefore also be used for tracking the machine 42 within a business concern. The RFID 62 may possibly already be connected as standard to the potentially hazardous machine 42.

FIG. 2 shows an illustration of the potentially hazardous machine 42 with an open cover, according to the first example embodiment. Shielding of the potentially hazardous machine 42 is no longer ensured when the cover 45 is open. Non-contacting data transmission takes place from the RFID 62 to the reader 44, and indicates the new state. The RFID 62 sends the code for the potentially hazardous machine 42 to the reader 44, as a result of which it is possible to tell that the potentially hazardous machine 42 can now be accessed from the outside.

The reader 44 is in this example embodiment provided for the purpose of sending an appropriate signal to the circuit breaker 49 via the control line 50. The circuit breaker 49 interrupts the power supply to the potentially hazardous machine 42, and thus precludes the risk of injury to an operator 52.

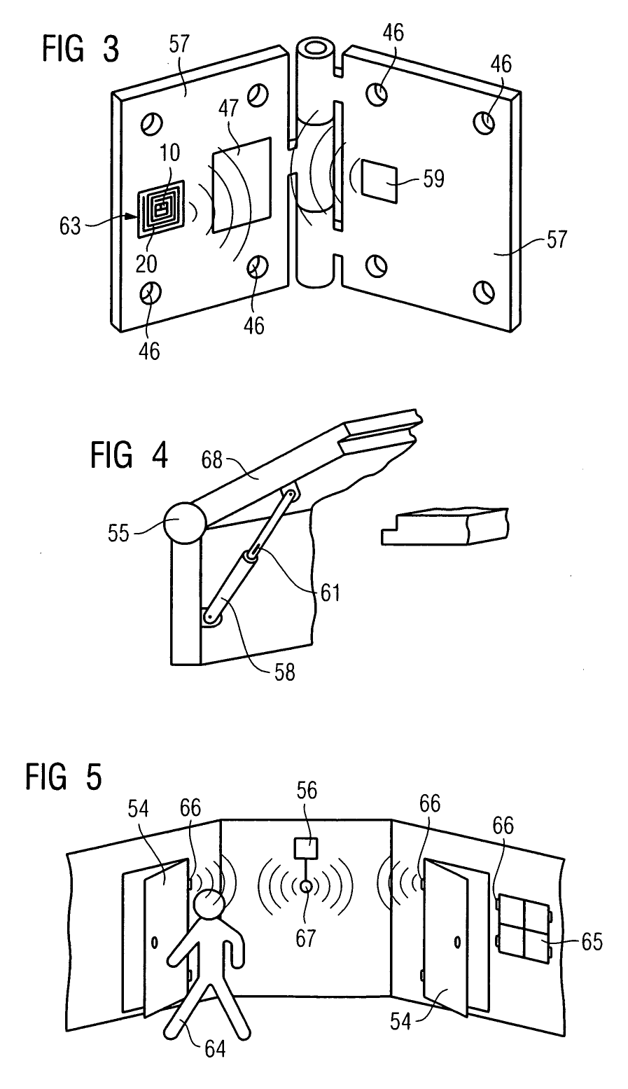

FIG. 3 shows a view of a position switch which is in the form of a hinge switch, according to a second example embodiment. In its left-hand hinge vane 57, the hinge switch has an RFID 63, which is illustrated with an integrated data store 10 and the coupling element 20. The right-hand hinge vane 57 is intended to hold the reader 44, in which case partial accommodation of the reader 44 is also feasible if, for example, only a transmitting unit of the reader 44 can be placed there, for space reasons. The illustrated switching state corresponds to the first state, in which the data can be read by the reader 44 from the data store 10 via the coupling element 20.

In consequence, the hinge switch acts as position switch which has two possible states. If the hinge switch is operated in such a manner that the two hinge vanes 57 are moved towards one another, this results in shielding of both the reader 44 and of the RFID 63. In the closed state, the hinge switch is in the second switching state.

Respective shielding of the reader 44 or of the RFID 63, or of both components at the same time, is possible by appropriate configuration of the hinge and/or of the hinge vanes 57. For example, it is thus also possible to additionally or alternatively use a shielding element 47 in an appropriate manner, instead of using the hinge vanes 57 as a shield. As shown in FIG. 3, the shielding element 47 is located opposite the reader 44, on the left-hand hinge vane 57. The reader can thus be shielded from the RFID 63 in the closed state.

In this case, the RFID 63 is likewise not active, since it is not supplied with power. It is also optionally possible to shield the RFID 63 by appropriately fitting a shielding element 47. The use of the shielding element 47 allows free choice of the material for the hinge switch, since the hinge vanes need not be used for shielding.

FIG. 4 shows a view of a position switch according to a third example embodiment. The illustrated position switch is equipped with a pneumatically assisted hinge 55. Furthermore, the position switch is intended to indicate the state of the door 68. The “door open” and “door closed” states correspond to the respective first and second state of the system. The RFID 61 is arranged in such a manner that it is integrated in the pneumatics. Non-contacting data transmission to a reader is possible in the first state. This indicates that the door 68 is open. In the second state, a pneumatic rod 70 on which the RFID 61 is arranged is mounted within the shielding element 58. This example embodiment shows that it must not only be possible to operate or move the means for shielding, but that it is likewise possible to shield the RFID 61 by moving it.

FIG. 5 shows an illustration of an alarm installation according to a fourth example embodiment. The illustration shows a room in which the operator 64 is located. Both doors 54 have an RFID position or hinge switch 66, as described in example embodiments 2 and 3. Furthermore, the window 65 has a hinge switch 66 of this type. Non-contacting data transmission takes place from the respective hinge switches 66 when a door 54 or the window 65 is opened.

As shown in FIG. 5, non-contacting data transmission takes place between the hinge switches 66 of the two doors 54 and the reader 67. The window 65 is closed, so that the RFID of the hinge switch 66 is shielded, and data transmission is not possible. The reader 67 is fitted centrally in the room, and is connected to a signal transmitter 56. The alarm installation can be designed in such a manner that an audible and/or visual signal is activated by the signal transmitter 56, and/or a message is emitted to a control centre when non-contacting data transmissions take place with one or more hinge switches 66.

In addition, the system may also be in the form of a safety or security gate. In this case, a message, or a safety or security measure, is initiated when at least two identifications/codes can be read from the hinge switch 66. Thus, initiation takes place only when the installation is in specific overall states.

For example, it is feasible that the room is intended to represent an airlock, in which at least one of the two doors 54 must always be closed. A measure such as this is worthwhile, for example, for clean rooms as well as for prison cells. The states of the airlock can be monitored by way of the illustrated installation. The reader 67 accordingly initiates an alarm only when non-contacting data transmission takes place from the hinge switches 66 of both doors 54.

In summary, at least one embodiment of the invention relates to a position switch and safety or security system for non-contacting state identification with at least two switching states, identification device(s) and device(s) for shielding, with the device(s) for shielding being provided in order to interrupt and reproduce a data transmission from a coupling element to a reader. The aim is thus to allow safe, reliable and secure state identification of the position switch, in a cost-efficient manner. The position switch according to at least one embodiment of the invention and the safety or security system may at least partially be in the form of a hinge switch or alarm installation.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A position switch, in particular a hinge switch, for non-contacting state identification with at least two states and at least one identification device, with the at least one identification device including at least one reader and at least one coupling element, which are provided for non-contacting data transmission using one transmission frequency, the position switch comprising:
at least one device for shielding for interrupting and reproducing data transmission from the coupling element to the reader, at least one device for shielding being activatable when a state change occurs.

2. The position switch as claimed in claim 1, wherein at least one of the reader and the coupling element are provided for shielding.

3. The position switch as claimed in claim 1, wherein a state of the position switch is indicatable by the use of at least one device of shielding.

4. The position switch as claimed in claim 1, wherein the device for shielding is provided for interruption and reproduction of a non-contacting power supply via the coupling element.

5. The position switch as claimed in claim 1, wherein the at least one device for shielding is coupled at least one of partially mechanically, and to a switching mechanism.

6. The position switch as claimed in claim 1, wherein the at least one device for shielding includes at least one metallic or metallized component.

7. The position switch as claimed in claim 1, wherein the data is readable in a non-contacting manner from a data store in a first state, and is not readable in a non-contacting manner in a second state.

8. The position switch as claimed in claim 7, wherein the data in the data store is provided for identification of a unit.

9. The position switch as claimed in claim 1, wherein the reader is provided as at least one of an integrated and mobile reader.

10. The position switch as claimed in claim 1, wherein the identification device includes a radio-frequency identifier.

11. The position switch as claimed in claim 1, further comprising at least one switching unit which includes at least two states, with the states being switching states.

12. At least one of a safety and security system including at least one position switch as claimed in claim 1.

13. The at least one of a safety and security system as claimed in claim 12, wherein at least one of a safety or security measure is initiatable and a message is sendable after state identification.

14. A method for non-contacting state identification of a position switch having at least two switching states, with at least one reader and at least one coupling element transmitting data in a non-contacting manner using one transmission frequency, the data transmission from the coupling element to the reader being interrupted and reproduced by way of shielding, that the method comprising:
activating at least one device for shielding when a state change occurs.

15. The method as claimed in claim 14, wherein a switching state is indicated by the use of at least one device for shielding.

16. The method as claimed in claim 14, wherein the at least one device for shielding interrupts and reproduces a non-contacting power supply via the coupling element.

17. The method as claimed in claim 14, wherein the data is read in a non-contacting manner from a data store in a first switching state, and is read in a non-contacting manner in a second state.

18. The method as claimed in claim 14, wherein the data in the data store identifies a unit.

19. The position switch as claimed in claim 2, wherein a state of the position switch is indicatable by the use of at least one device of shielding.

20. The position switch as claimed in claim 2, wherein the device for shielding is provided for interruption and reproduction of a non-contacting power supply via the coupling element.

21. The position switch as claimed in claim 1, wherein the position switch is a hinge switch.

22. The method as claimed in claim 15, wherein the at least one device for shielding interrupts and reproduces a non-contacting power supply via the coupling element.

23. The method as claimed in claim 15, wherein the data is read in a non-contacting manner from a data store in a first switching state, and is read in a non-contacting manner in a second state.

24. The method as claimed in claim 15, wherein the data in the data store identifies a unit.
